(19) United States
(12) Patent Application Publication
(10) Pub. No.: US 2002/0051311 A1
(43) Pub. Date: May 2, 2002

(54) The ejecting arm device for opening and closing the cassette door

(75) Inventor: Yongda Chen, Shenzhen (CN)

Correspondence Address: LOWE HAUPTMAN GOPSTEIN, GILMAN AND BERNER LLP, SUITE 310, 1700 DIAGONAL ROAD, ALEXANDRIA, VA, 22314

(73) Assignee: Valley Wood Ltd.

(21) Appl. No.: 09/983,360

(22) Filed: Oct. 24, 2001

(30) Foreign Application Priority Data
Nov. 2, 2000 (CN) 00257407.1

(51) Int. Cl. G11B 15/00

(52) U.S. Cl. 360/96.5

(57) ABSTRACT

The present utility model belongs to domestic appliances, especially to ejecting arm devices for opening and closing the cassette door of tape recorders, video players or cameras. A pushing rod 2-1 is provided at at least one edge of the magnetic head board 2; an ejecting arm 1 is mounted on the chassis 50 between the magnetic head board 2 and at least one edge of the cassette-entering opening. The shape of the ejecting arm 1 is like [symbol] . The pushing rod 2-1 is embedded in the groove 1-1 at one end of the ejecting arm 1, and at the other end is a locking head 1-2 away from the edge of the cassette-entering opening. This device can lock the cassette door, so that the cassette door can't be loosened during the operation of the drive unit in tape recorders, video players or cameras, and avoid making noise and causing tape being eaten.

The present utility model belongs to domestic appliances, especially to ejecting arm devices for opening and closing the cassette door of tape recorders, video players or cameras.

There are various models of tape recorders, video players or cameras available in the market. As a part of the tape recorder, video player or camera, the device for opening and closing the cassette door is also designed in numerous models. In the earlier model, an additive spring is mounted on the cassette door, so that the cassette door can be opened or closed. Gradually, however, it was noticed that this kind of cassette door not only has a short lifetime, but also produces a noise due to the strong friction. Therefore, various types of cassette door have been invented, such as the slow-opening cassette door with small gears and belt pulley cassette door. But no matter how smart were the designs of these cassette doors, there are still some disadvantages. Since the locking hook for locking the cassette door cannot function properly when the tape recorder, video player or camera is subject to vibration, it will easily cause the cassette door to be loosened, the rolling tape to be at random rotation, the machine to make noise and the tape to be eaten.

The objective of this utility model is to overcome the disadvantage of the current cassette door opening and closing device, in that cassette door can be loosened when the tape recorder, video player or camera is subject to vibration, and to provide a new ejecting arm device for opening and closing the cassette door of the tape recorders, video players or cameras, to prevent the cassette door from being loosened, and ensure the proper operation of the tape recorders, video players or cameras.

The objective of this utility model is carried out in the following way:

This utility model includes a magnetic head board and a chassis, wherein, a pushing rod 2-1 is provided at at least one edge of the magnetic head board 2; an ejecting arm 1 mounted on the chassis 50 between the magnetic head board 2 and at least one edge of the cassette-entering opening. A pushing rod (2-1) is embedded in the groove 1-1 at one end of the ejecting arm 1, and at the other end is a locking head 1-2 away from the edge of the cassette-entering opening.

One said pushing rod 2-1 is mounted at each edge of the magnetic head board 2, and one ejecting arm 1 is mounted on the chassis between the magnetic head board and each edge of the cassette-entering opening. The said groove 1-1 is narrower on top and wider at the bottom. The shape of the ejecting arm 1 is like

[symbol]

The ejecting arm device of this utility model can lock the cassette door so that the cassette door can not be loosened when the machine is subject to vibration, thereby, it will prevent the cassette door from being loosened during the operation, avoid making noises and causing the tape to be eaten.

Below is a further description of the technical scheme of this utility model in connection with the appended figures and embodiment.

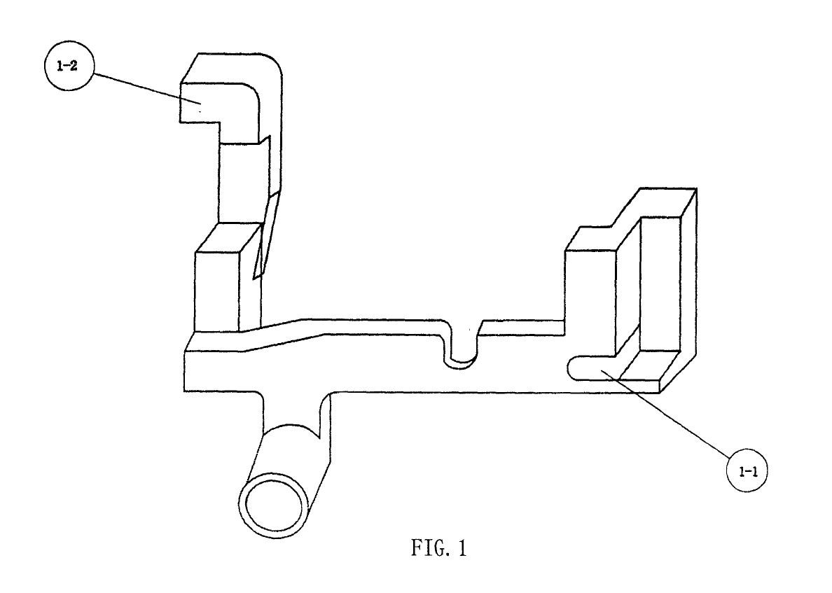

FIG. 1 is an outline schematic view of this utility model;

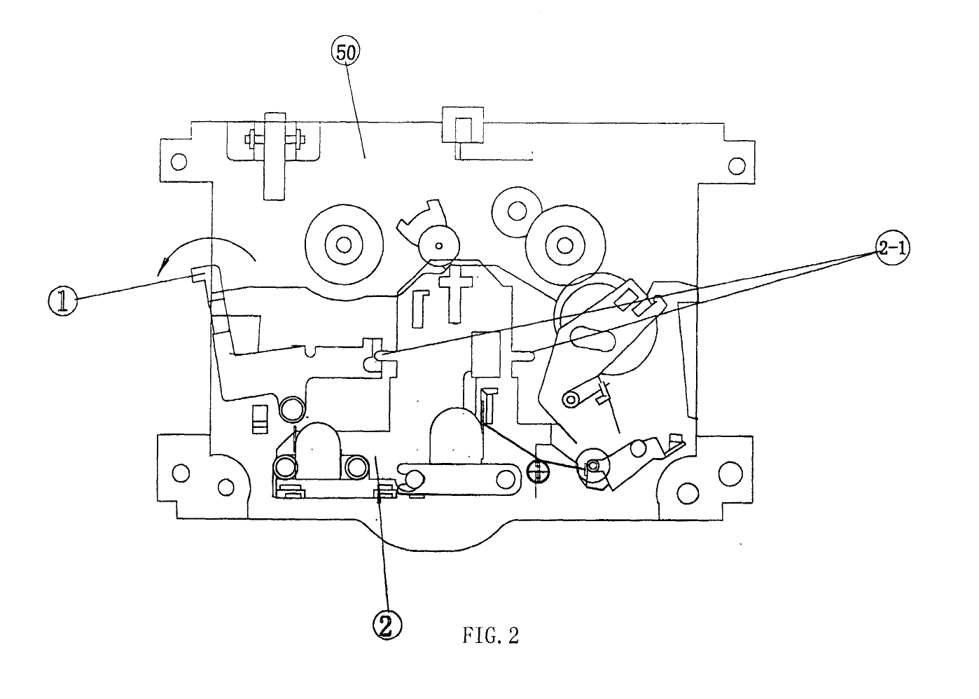

FIG. 2 is a schematic view of this utility model during operation;

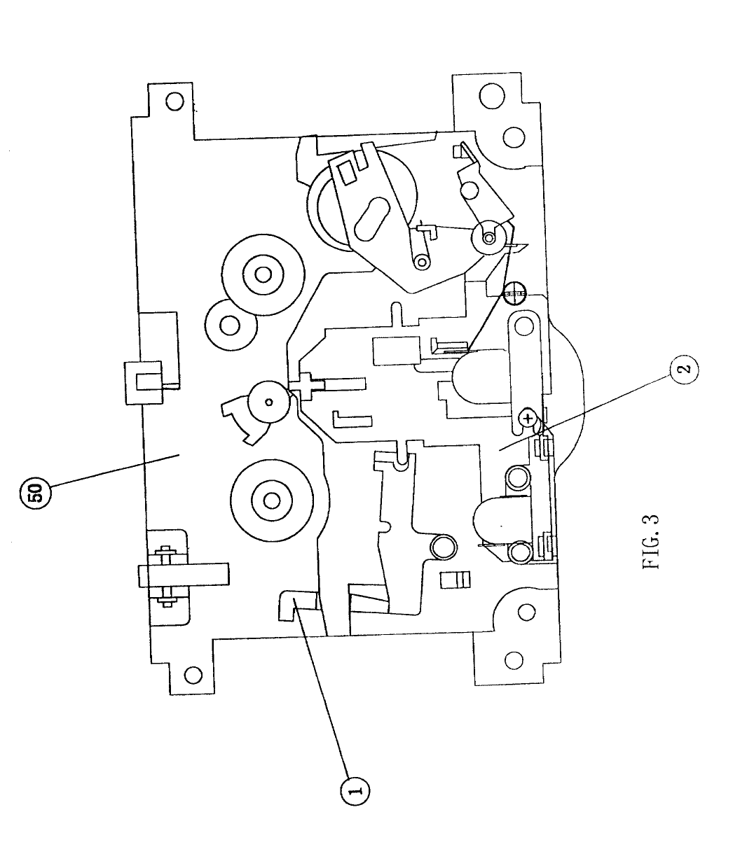

FIG. 3 is a schematic view of this utility model during stop;

1. Ejecting Arm 1-1. Groove 1-2. Locking Head

2. Magnetic Head Board 2-1. Pushing Rod 50. Chassis

### The Embodiment

See FIGS. 1. 2 & 3., a pushing rod 2-1 is provided at each edge of the magnetic head board 2; an ejecting arm 1 is mounted on the chassis 50 between the magnetic head board 2 and each edge of the cassette-entering opening. The shape of the ejecting arm 1 is like [symbol] A pushing rod (2-1) is embedded in the groove 1-1 at one end of the ejecting arm 1. The shape of the groove 1-1 is like “┘” (See FIG. 1). At the other end is a locking head 1-2 away from the edge of the cassette-entering opening.

When the tape recorder, video player or camera is started, the ejecting arm 1 is pushed by the magnetic head board 2, causing the locking head 1-2 to dash outwardly and the cassette door of the machine to be securely locked. At this time, the pushing rod 2-1 is embedded in the narrower portion of the groove 1-1 bearing the pushing force in conjunction with the magnetic head board (see FIG. 2). When the tape recorder, video player or camera is stopped, the ejecting arm 1 is pulled back by the magnetic head board 2, the cassette door is loosened and returns to its normal state. At this time, the pushing rod 2-1 is in wider portion of the groove 1-1 (See FIG. 3).

The disposition of the utility model of the ejecting arm device can prevent the cassette door from being loosened, making noises and causing tape to be eaten during the operation.

While this utility model has been described with reference to the figures and embodiments, it will be understood that various changes within the spirit and scope of this utility model as defined by the appended claims are effected.

1. An ejecting arm device for opening and closing the cassette door, including a magnetic headboard and a chassis, wherein, a pushing rod (2-1) is provided at at least one edge of the magnetic head board (2); an ejecting arm 1 is mounted on the chassis (50) between the magnetic head board (2) and at least one edge of the cassette entering opening. The pushing rod (2-1) is embedded in the groove (1-1) at one end of the ejecting arm (1), and at the other end is a locking head (1-2) away from the edge of cassette-entering opening.

2. The ejecting arm device as described according to claim 1, wherein, the said pushing rod (2-1) is provided at each edge of the said magnetic head board (2).

3. The ejecting arm device as described according to the claim 1, wherein, the said ejecting arm (1) is mounted on the chassis between the magnetic head board (2) and each edge of the cassette-entering opening.

4. The ejecting arm device as described according to claim 1, wherein, the said groove (1-1) is narrower on top and wider at the bottom.

5. The ejecting arm device as described according to claim 1, wherein, the shape of the said ejecting arm (1) is like [symbol]
